(19) United States
(12) Patent Application Publication
(10) Pub. No.: US 2010/0231788 A1
(43) Pub. Date: Sep. 16, 2010

(54) PLAYBACK SYSTEM AND METHOD SYNCHRONIZING AUDIO AND VIDEO SIGNALS

(76) Inventors: Chao-Kuei Tseng, Tainan County (TW); Lin-Kai Bu, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/401,625

(22) Filed: Mar. 11, 2009

(51) Int. Cl. H04N 9/475; H04N 7/26

(52) U.S. Cl. 348/512; 386/109; 348/E09.034

(57) ABSTRACT

A playback system that utilizes a serial link for transmitting video and audio data from a host to a playback device includes a host and a playback device. The host is utilized to generating graphic packets, video packets, and audio packets according to input data, and to generating control packets according to a host clock. Then, the host transmits the packets through a serial port, wherein the graphic packets are transmitted only when the host receives a request. The playback device is coupled to the host via the serial port, and is implemented to decoding the received packets from the serial port to generate decoded data, and to generate a playback clock according to the control packets. Then the playback device performs a playback operation according to the decoded data and the playback clock.

### BACKGROUND OF THE INVENTION

1. Field of the Invention

The present invention relates to video/audio transmission between a playback device and a host, and more particularly, to a playback system and method of utilizing a serial communication means (e.g., a USB link) for connecting a playback device and a host.

2. Description of the Prior Art

Generally speaking, a D-subminiature (D-sub) interface or a Digital Visual Interface (DVI) is used in playback systems for transmitting a video signal (RGB video signal) from a host device to a monitor that carries video signals only. Generally speaking, a D-subminiature (D-sub) interface or a Digital Visual Interface (DVI) is used in playback systems for transmitting a video signal (RGB video signal) from a host device to a monitor that carries video signals only. However, High-Definition Multimedia Interface (HDMI), which is capable of simultaneously transmitting uncompressed video and audio digital signal from a host device to a playback device (usually comprises a monitor having speakers), is an increasingly popular interface often seen in multimedia products, e.g. a game console that utilizes an HDMI interface to connect a high definition TV.

Please refer to FIG. 1. FIG. 1 is a diagram illustrating a conventional playback system 10. A host device 100 has three options for connecting a monitor 120 with a built-in speaker 130 for simultaneously transmitting video and audio signals to the monitor 120. The three options are, respectively: 1) a D-sub cable combined with an audio cable (e.g. a Radio Corporation of America (RCA) jack); 2) a DVI cable combined with an audio cable; 3) an HDMI cable. All cables and related connectors used in the said three options have specific sizes and weight, which are inconvenient for a user to constantly carry if both the host device 100 and the monitor 120 are portable (e.g. a personal digital assistant (PDA) and a small-scaled LCD monitor).

Furthermore, the sizes of the conventional connectors mean the manufacturer must preserve certain areas on the backplane of the host device for fitting the connecting ports required for coupling the different video/audio cables. As a result, the size of the host device is limited by the backplane.

### SUMMARY OF THE INVENTION

Compared with the conventional video interfaces, the Universal Serial Bus (USB) interface has a smaller connector and a relatively thin cable, which is more convenient for users to carry and is already widely used in data transmission over different peripherals and hosts. Furthermore, the USB link complying with the USB 2.0 specification is able to provide a bandwidth of up to 480 Mb/s in high-speed mode, which is sufficient for the overhead of both video and audio data transmission. Consequently, it is one objective of the present invention to provide a playback system and related playback method based on a USB link for transmitting video and audio data from a host to a playback device (e.g., a monitor having a built-in speaker). Furthermore, the present invention provides a method for achieving synchronization of video and audio in a playback operation of a playback device in the playback system.

According to one exemplary embodiment of the present invention, a playback system is disclosed. The playback system includes a host and a playback device. The host is utilized to generate graphic packets, video packets, and audio packets according to input data, and to generate control packets according to a host clock. Then, the host transmits the packets through a serial port, wherein the graphic packets are transmitted only when the host receives a request. The playback device is coupled to the host via the serial port and implemented for decoding the received packets from the serial port to generate decoded data, for generating a playback clock according to the control packets. Then the playback device performs a playback operation according to the decoded data and the playback clock.

A related playback method is provided in accordance with another exemplary embodiment of the present invention. The playback method includes: generating graphic packets, video packets, and audio packets according to input data, for generating control packets according to a host clock; transmitting the packets via a serial port wherein the graphic packets are transmitted only when the host receives a request; decoding the packets to generate decoded data and a playback clock, wherein the playback clock is generated according to the control packets; and performing a playback operation in a playback device according to the decoded data and the playback clock.

Preferably, the control packets are encoded with synchronization information to the playback device based on the host clock, and the playback clock is generated according to the synchronization information of the control packets.

Preferably, each of the video packets and the audio packets is encoded with corresponding presentation timestamp and the playback device synchronizes audio and video playback according to the presentation timestamps and the playback clock.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional playback system.

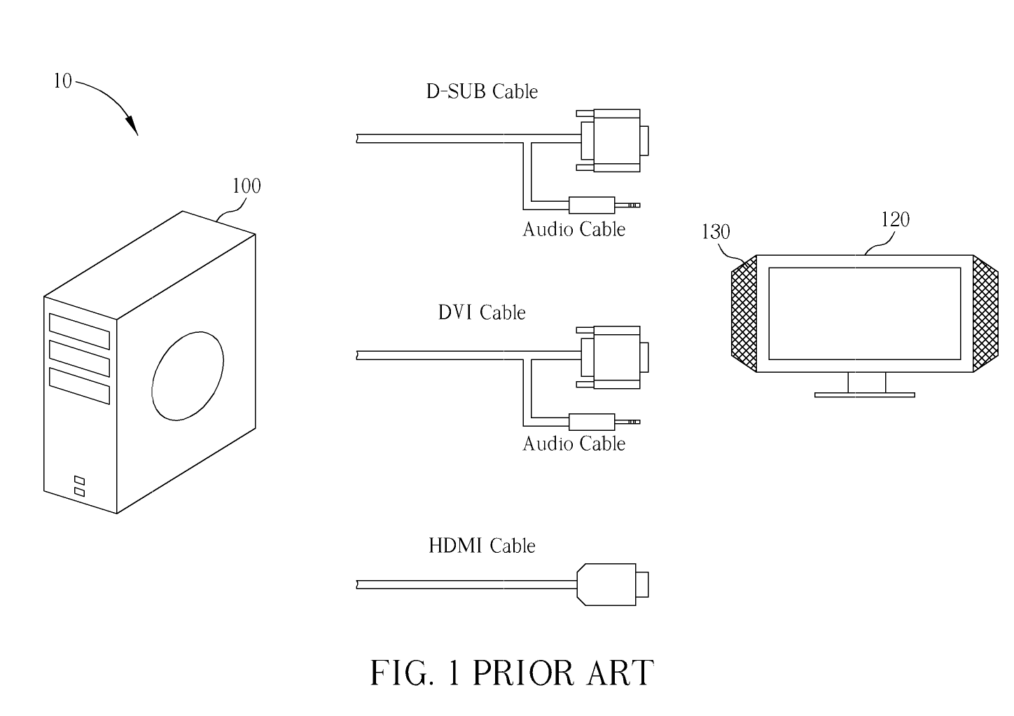

FIG. 2 is a block diagram of a playback system according to one exemplary embodiment of the present invention.

FIG. 3 is a diagram showing the multiplexing of packets of a host.

FIG. 4 is a flowchart illustrating operations of a playback method according to another exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

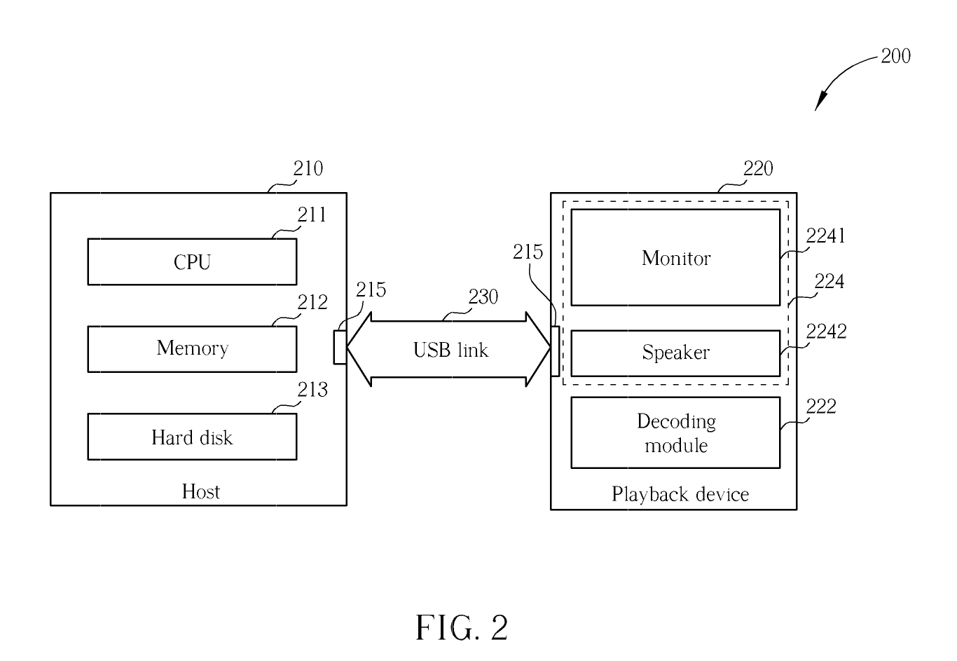

Please refer to FIG. 2, which illustrates a playback system according to one exemplary embodiment of the present invention. The playback system 200 includes a host 210 and a playback device 220. The host 210 includes, but is not limited to, a central processing unit (CPU) 211, a memory 212, a hard disk 213, and a USB port 215. The playback device 220 includes, but is not limited to, a USB port 215, a decoding module 222 and an output module 224. In this exemplary embodiment, the output module 224 includes a monitor 2241 for image and/or video playback and a speaker 2242 for audio playback. Detailed descriptions of the playback system 200 are explained in the following.

A playback device driver executed by the CPU 211 is utilized for decoding input data into a plurality of packets and transmitting packets to the playback device 220 through the USB port 215, where input data are loaded from the memory 212 and the hard disk 213 and are meant for playback on the playback device 220 (e.g. displayed on the monitor 2241 and/or played through the speaker 2242). For instance, the input data can be derived from a movie file, an audio file, a still image, and so on. For fitting the maximum bandwidth of the USB link 230 established between the host 210 and the playback device 220, the input data further could be properly encoded with corresponding presentation timestamp by the playback device driver executed by the CPU 211 before transmission. After encoding, the input data are decoded into packets for transmission. The host 210 starts to transmit the plurality of packets to the playback device 220 through the USB port 215 and the USB link 230. It should be noted that the USB port 215 and the USB link 230 utilized in the present invention are for illustrative purposes only, and are not meant to be limitations of the scope of the present invention. For example, any other transmission port is feasible after proper modification made to the afore-mentioned design, without departing from the spirit of the present invention.

In one exemplary implementation of the present invention, the playback device driver generates four kinds of packets, including audio packets, video packets, graphic packets, and control packets, wherein the first three kinds of packets are generated from the input data and the control packets are generated according to a host clock. Specifically, the playback device driver executed by the CPU 211 of the host 210 generates the control packets utilized for providing timestamp information to the playback device 220.

Firstly, a time relationship will be established between the host 210 and the playback device 220 for synchronization, since video and audio data carried by packets are transmitted asynchronously. The control packets comprising local timestamp information of the host 210 based on the host clock will be transmitted to the playback device 220 in advance. The playback device 220 receives the control packets, and then generates a playback clock according to the control packets. Further, the playback clock is synchronized with the host clock. Moreover, in addition to timestamp information, the control packets can comprise other control signals used for controlling the playback device 220 to generate the playback clock, which are well known to those skilled in the art, and related descriptions are therefore omitted here for the sake of brevity.

The host 210 generates packets for carrying visual content and audio data. The packets carrying visual content of the host 210 can be classified into two packet categories: graphic packets and video packets. The graphic packets defined in this invention are used to carry visual data which is not related to the audio data, and do not need to be synchronized with audio (e.g. a still image or a display of graphical user interface (GUI)). Therefore, the graphic packets do not be encoded with any presentation timestamp. The video packets defined in this invention are used to carry visual data which is associated with the audio data, and are required to be synchronized with audio (e.g. video compressed with audio in a single movie file). Thus, each of the video packets and the audio packets is encoded with corresponding presentation timestamp.

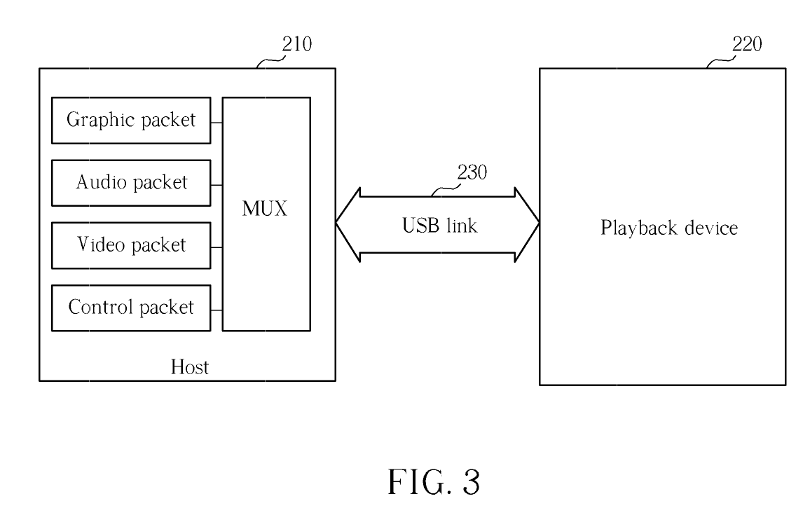

The control packets, graphic packets, video packets and audio packets will be multiplexed for transmission to the playback device 220 through the USB port 215 and the USB link 230 as shown in FIG. 3, and all packets will be properly multiplexed to the playback device 220 for synchronizing the audio and video data in sequence. When the playback device 220 receives the packets, the decoding module 222 derives received data carried by the control packets, graphic packets, the video and audio packets, and then decodes the received data to generate decoded data including the control data, the graphic data, the video and the audio data for playback. For example, the playback device driver generates the control packets according to the host clock, and generates the graphic packets, the audio packets, and the video packets according to the input data. The audio and video packets are multiplexed for transmission to the playback device 220 behind the control packets. The decoding module 222 of the playback device 220, firstly, decodes the control packets to generate the playback clock, and then decodes the following received video and audio packets to extract presentation timestamps of the video and audio packets. The graphic packets are transmitted only when the host 210 receives a request. The output module 224 performs the playback operation to synchronize video and audio data according to the playback clock and the presentation timestamps of the video and audio packets. The monitor 2241 is utilized for the video playback according to the decoded video data, while the speaker 2242 is utilized for the audio playback according to the decoded audio data.

In another case where the user only wants to play the music file without any video data, the host 210 transmits the audio packets, and transmits the graphic packets only when the host 210 receives a request. Thus, the playback quality is not severely limited by the bandwidth of the USB link due to the timestamp information in the packets.

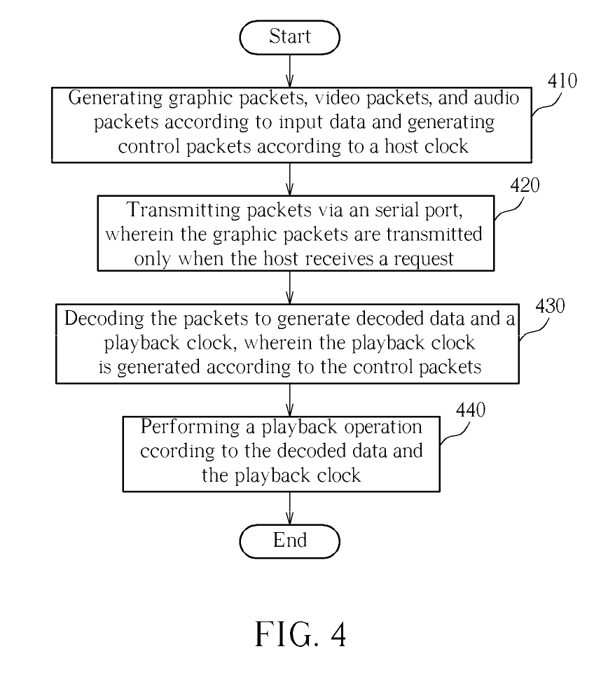

The operations of the playback system of the present invention are summarized using the following steps of a related playback method employed by the playback system. Please refer to FIG. 4, which is a flowchart illustrating operations of a playback method in a playback device according to another exemplary embodiment of the present invention. In step 410, generating graphic packets, video packets, and audio packets according to input data and generating control packets according to a host clock. Moreover, the control packets are encoded with synchronization information based on the host clock, and each of the video packets and the audio packets is encoded with corresponding presentation timestamp. For instance, the input data can be derived from a movie file, an audio file, a still image, and so on.

In step 420, the packets are multiplexed to the USB port and then transmitted via the USB port, wherein the graphic packets are transmitted only when the host receives a request.

In step 430, the packets received from the USB port are decoded to generate decoded data and a playback clock, wherein the playback clock is generated according to the synchronization information of the control packets. The playback clock may be synchronized with a host clock of the host side.

In step 440, a playback operation in the playback device is performed for synchronizing audio and video according to the decoded data and the playback clock. That is, the playback operation synchronizes audio and video for playback according to the presentation timestamps and the playback clock. As a person skilled in the art would readily understand details of the steps shown in FIG. 4 after reading the above disclosure directed to the playback system shown in FIG. 2, further description is omitted here for the sake of brevity.

In one exemplary implementation of the present invention, a USB transmission is used for delivering data which are conventionally converted into video and audio signals and then transmitted via a conventional interface, such as an HDMI interface. Compared to the conventional designs, the present invention employing the USB connecting interface provides higher flexibility and greater convenience.

Those skilled in the art will readily observe that numerous modifications and alterations of the device and method may be made while retaining the teachings of the invention.

What is claimed is:

1. A playback system for synchronizing the audio and video signals, comprising:
a host, for generating graphic packets, video packets, and audio packets according to input data, for generating control packets according to a host clock, and for transmitting the packets through a serial port, wherein the graphic packets are transmitted only when the host receives a request; and
a playback device, coupled to the host via the serial port, for decoding the received packets from the serial port to generate decoded data, for generating a playback clock according to the control packets, and for performing a playback operation according to the decoded data and the playback clock.

2. The playback system of claim 1, wherein the control packets are encoded with synchronization information based on the host clock, and the playback device generates the playback clock according to the synchronization information of the control packets.

3. The playback system of claim 2, wherein each of the video packets and the audio packets is encoded with corresponding presentation timestamp and the playback device synchronizes audio and video playback according to the presentation timestamp of the video packets and the audio packets and the playback clock.

4. The playback system of claim 1, wherein the playback device comprises:
a decoding module for receiving the packets from the serial port, and decoding the received packets to generate the decoded data and the playback clock; and
an output module, coupled to the decoding module, for performing the playback operation upon the decoded data and the playback clock.

5. The playback system of claim 1, wherein the host further comprises:
a memory, for providing the input data; and
a central processing unit, for generating the graphic packets, the video packets, the audio packets, and the control packets according to the input data and the host clock.

6. The playback system of claim 1, wherein the serial port is an USB port.

7. A playback method, comprising:
generating graphic packets, video packets, and audio packets according to input data, for generating control packets according to a host clock;
transmitting the packets via a serial port, wherein the graphic packets are transmitted only when a request is received;
decoding the packets to generate decoded data and a playback clock, wherein the playback clock is generated according to the control packets; and
performing a playback operation in a playback device according to the decoded data and the playback clock.

8. The playback method of claim 7, wherein the control packets are encoded with synchronization information based on the host clock, and the playback clock is generated according to the synchronization information of the control packets.

9. The playback method of claim 8, wherein each of the video packets and the audio packets is encoded with corresponding presentation timestamp and the step of performing a playback operation according to the decoded data and the playback clock, further comprises:
synchronizing audio and video playback according to the presentation timestamps and the playback clock.

10. The playback method of claim 7, wherein the serial port is an USB port.
